(19) United States
(12) Patent Application Publication
(10) Pub. No.: US 2022/0241795 A1
(43) Pub. Date: Aug. 4, 2022

(54) CONTINUOUS SLUICING DEVICE, AND METHOD OF MANUFACTURING SAME

(71) Applicant: Alex Istvan POMEDLI, Vancouver (CA)

(72) Inventor: Alex Istvan POMEDLI, Vancouver (CA)

(21) Appl. No.: 17/588,397

(22) Filed: Jan. 31, 2022

(30) Foreign Application Priority Data
Feb. 2, 2021 (CA) 3107996

(51) Int. Cl. B02C 23/10; B02C 23/36; B02C 23/16; B03B 5/26; B03B 5/56

(52) U.S. Cl. CPC B02C 23/10; B02C 23/36; B02C 2023/165; B03B 5/26; B03B 5/56; B02C 23/16

(57) ABSTRACT

Described are various embodiments of a continuous sluicing device, and method of manufacturing same. One aspect relates to a rotatable sluicing device comprising an inner trommel and an outer separating cylinder, wherein the outer separating cylinder comprises a rifled baffling portion disposed on an inner surface thereof. The rifled baffling portion comprises a helical collection riffle and one or more spiral fighting portions disposed near and substantially parallel to an edge of the helical collection riffle. Rotation of the inner trommel portion and outer separating cylinder urges lower density substrates to discharge from respective discharge ends thereof, and urges heavy particulate material in the helical collection riffle to move upstream for collection in a collection reservoir.

### CROSS REFERENCE TO RELATED APPLICATION

This application claims priority to Canadian Patent Application No. 3,107,996 filed Feb. 2, 2021, the entire disclosure of which is hereby incorporated herein by reference.

### FIELD OF THE DISCLOSURE

The present disclosure relates to mining, and, in particular, to a continuous sluicing device, and method of manufacturing same.

### BACKGROUND

Conventional sluicing devices typically extract valuable materials from ore using generally planar sluicing surfaces that comprise ridges. A slurry of ore and water is washed over the surface, with dense particulates concentrating near the ridges for subsequent retrieval after less dense substrates are washed away. More recent innovations have focused on improving the efficiency of such systems. For instance, U.S. Pat. No. 8,789,780 entitled “Method for extracting heavy metals from hard rock and alluvial ore” and issued Jul. 29, 2013 to Brosseuk discloses a process employing a machine that combines an inner trommel device with a rotating drum that allows for a pre-separated ore to be deposited on a sluice box. Sluice boxes, however, typically have the drawback of requiring a system shutdown, often for hours a day, for cleaning and retrieval of heavy particulates from catchment devices, which reduces productivity and efficiency.

Conversely, United States Patent Application No. 2013/0181077 entitled “Concentrator apparatus for recovering lead or other material” and published Jul. 18, 2013 to Harris and Marks discloses a system employing, again, a combination of an inner trommel portion and an outer cylinder for the separation of lead from soil. In this example, the outer cylinder is ribbed with flat baffles to trap recoverables upstream of the baffles for automatic removal upon rotation of the outer cylinder, allowing for more continuous sluicing.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a continuous sluicing device, and method of manufacturing same that overcome some of the drawbacks of known techniques, or at least, provides a useful alternative thereto. Some aspects of this disclosure provide examples of such systems and methods.

In accordance with one aspect, there is provided a rotatable sluicing device for separating a heavy particulate material from lower density substrates and oversized particles in ore, the rotatable sluicing device comprising: an inner trommel portion disposed substantially concentrically within an outer separating cylinder, the inner trommel portion comprising one or more porous regions to allow a material passage under a predetermined particle size therethrough to the outer separating cylinder, the outer separating cylinder comprising a rifled baffling portion disposed on an inner surface thereof and comprising: a helical collection riffle; and one or more spiral flighting portions disposed near and substantially parallel to an edge of the helical collection riffle; a drive means for rotating the inner trommel portion and the outer separating cylinder; and a fluid inlet for providing a liquid at a designated flow rate onto the inner surface of the outer separating cylinder for creating a slurry with the liquid and material received on the inner surface from the one or more porous regions; wherein rotation of the inner trommel portion and the outer separating cylinder urges the lower density substrates to discharge from respective discharge ends thereof, and urges the heavy particulate material in the helical collection riffle to move upstream, opposite the respective discharge ends, for collection in a collection reservoir.

In one embodiment, the inner trommel portion is operably coupled to the outer separating cylinder so to synchronously rotate therewith.

In one embodiment, the one or more spiral flighting portions extends inwardly from the inner surface of the outer separating cylinder.

In one embodiment, the one or more spiral flighting portions comprises a baffling portion extending inwardly at a designated angle from the inner surface of the outer separating cylinder, and a flight portion extending substantially in a direction towards the discharge end.

In one embodiment, the helical collection riffle comprises a groove on the inner surface of the outer separating cylinder.

In one embodiment, the outer separating cylinder comprises a corrugated tube, and the helical collection riffle being a corrugation of the corrugated tube.

In one embodiment, the corrugated tube is an injection moulded plastic tube or an extruded metal tube.

In one embodiment, the one or more spiral fighting portions is continuous along the inner surface of the outer separating cylinder.

In one embodiment, one or more of the spiral fighting or the helical collection riffle comprises a non-uniform radial profile along a longitudinal axis of the outer separating cylinder.

In one embodiment, one or more spiral fighting portions and the helical collection riffle have a variable pitch relative to the inner surface of the outer separating cylinder.

In one embodiment, one or more spiral flighting portions is reversibly coupled to the inner surface of the outer separating cylinder.

In one embodiment, the one or more porous regions of the inner trommel portion comprises one or more classifying meshes.

In one embodiment, the device further comprises a material input reservoir for introducing the ore into the inner trommel portion.

In one embodiment, the material input reservoir comprises an object size limiting means for permitting the passage of particles under predetermined size into the inner trommel portion.

In one embodiment, the device further comprises a conveyor system operable for continuously introducing ore to the material input reservoir.

In one embodiment, the drive means comprises one or more of a drive belt or a pulley system.

In one embodiment, the drive means comprises a motor.

In one embodiment, the drive means is operable to provide variable rotational speed to the inner trommel portion and the outer separating cylinder.

In one embodiment, the device further comprises a support frame configured for positioning the inner trommel portion and the outer separating cylinder at an angle relative to horizontal.

In one embodiment, the support frame comprises a U-shaped frame in which said inner trommel portion and said outer separating cylinder are disposed. The outer separating cylinder may be rotatable along a longitudinal axis by one or more rotatable bearings.

In one embodiment, the one or more rotatable bearings comprise one or more cylinders.

In one embodiment, the support frame comprises an adjustable leg.

In one embodiment, the one or more spiral fighting portions is disposed near and substantially parallel to an upstream edge of the helical collection riffle.

In accordance with another aspect, there is provided a barrel for use in a rotating sluice, the barrel comprising: a substantially rotationally symmetric open-ended elongated hollow body having respective upstream and downstream end regions and comprising, on an inner surface thereof: a helical collection riffle; and a spiral fighting disposed near and substantially parallel to an edge of the helical collection riffle; wherein the helical collection riffle and the spiral fighting are configured to separate heavy particulates from a slurry flowing from the upstream end region to the downstream end region and, upon rotation of the substantially rotationally symmetric open-ended elongated hollow body, urge the separated heavy particulates towards the upstream end region.

In one embodiment of the barrel, the barrel is configured to be inserted into a rotating sluicing apparatus.

In one embodiment of the barrel, the spiral flighting extends inwardly from the inner surface.

In one embodiment of the barrel, the spiral fighting comprises a baffling portion extending inwardly at a designated angle from the inner surface and a flight extending substantially in a direction towards the downstream end.

In one embodiment of the barrel, the helical collection riffle comprises a groove on the inner surface.

In one embodiment of the barrel, the substantially rotationally symmetric open-ended hollow body comprises a corrugated tube, and the helical collection riffle being a corrugation of the corrugated tube.

In one embodiment of the barrel, the corrugated tube is an injection moulded plastic tube or an extruded metal tube.

In one embodiment of the barrel, the spiral fighting is continuous along the inner surface.

In one embodiment of the barrel, one or more of the spiral fighting or the helical collection riffle comprises a non-uniform radial profile along a longitudinal axis of the substantially rotationally symmetric open-ended elongated hollow body.

In one embodiment of the barrel, the spiral flighting and the helical collection riffle have a variable pitch along a longitudinal axis of the substantially rotationally symmetric open-ended elongated hollow body.

In one embodiment of the barrel, the substantially rotationally symmetric open-ended elongated hollow body, the spiral fighting, and the helical collection riffle comprise a monolithic structure.

In one embodiment of the barrel, the spiral fighting is irreversibly coupled with the inner surface.

In one embodiment of the barrel, the spiral fighting is reversibly coupled with the inner surface.

In one embodiment of the barrel, the barrel is configured for rotatable coupling with a drive means.

In one embodiment of the barrel, the barrel is configured for rotatable coupling with the drive means via one or more of a gear, a cog, or a sprocket.

In one embodiment of the barrel, the barrel is configured for rotatable coupling with the drive means via one or more of a belt, a chain, a rope, or a pulley system.

In one embodiment of the barrel, an outer surface of the barrel is configured for rotational communication with a rotatable bearing mountable to a support frame.

In one embodiment of the barrel, the rotatable bearing comprises a cylindrical structure.

In one embodiment of the barrel, the spiral fighting is disposed near and substantially parallel to an upstream edge of the helical collection riffle.

In one embodiment of the barrel, the helical collection riffle comprises a square profile.

In one embodiment of the barrel, the helical collection riffle comprises a rounded profile.

In one embodiment of the barrel, the substantially rotationally symmetric open-ended elongated hollow body comprises a geometry that is substantially one or more of cylindrical, conical, strobilate, infundibular, hourglass-shaped, turbinate, ellipsoidal or shaped like an inverted double cone.

In accordance with another aspect, there is provided a method of manufacturing a sluicing barrel for use in a rotating sluice. The method comprises providing a substantially rotationally symmetric open-ended elongated hollow body comprising a helical collection riffle on an inner surface thereof. The method further comprises providing at least one rigid flighting material portion, and coupling the at least one rigid flighting material portion to an inner surface of the substantially rotationally symmetric open-ended elongated hollow body such that the at least one rigid fighting material portion defines a spiral fighting near and substantially parallel to an edge of the helical collection riffle.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1A is a cross-sectional left-side view of an exemplary rotational sluicing system, and FIG. 1B is a front perspective sectional view of some elements of the system of FIG. 1A taken along line 1B-1B, in accordance with various embodiments;

FIG. 2 is a top-left-side perspective view of the exemplary outer cylinder of FIG. 1A, in accordance with various embodiments;

FIG. 3 is a cross-sectional view of the exemplary outer cylinder of FIG. 2 taken along the line 3, in accordance with one embodiment;

FIG. 4 is a zoomed longitudinal cross-sectional view schematic of a portion of the exemplary outer cylinder of FIG. 3 during system operation, in accordance with one embodiment;

FIG. 5A is a top-left-side perspective view of an exemplary outer cylinder, and FIG. 5B is a cross-sectional view of the exemplary cylinder taken along the line 5B-5B of FIG. 5A, in accordance with one embodiment;

FIG. 6A is a top-left-side perspective view of an exemplary outer cylinder comprising more than one component, and FIG. 6B is a cross-sectional view of the exemplary cylinder of FIG. 6A taken along the line 6B-6B, in accordance with one embodiment;

FIG. 7 is a partial longitudinal cross-sectional view of various exemplary components of an exemplary outer cylinder in which spiral flighting is fastened to the inner surface of the cylinder, in accordance with various embodiments;

FIGS. 8A to 8X are schematics of exemplary spiral fighting configurations, in accordance with various embodiments;

FIG. 9 is a partial longitudinal cross-sectional view of an exemplary monolithic outer cylinder and fighting configuration, in accordance with one embodiment;

FIGS. 10A to 10C are schematical representations of an exemplary sluicing barrels comprising fighting of non-uniform height and non-uniform pitch, in accordance with various embodiments; and

FIG. 11A is a schematic of an exemplary continuous rotational sluicing apparatus, in accordance with one embodiment, and FIG. 11B is a is a front view of various components of the continuous rotational sluicing apparatus of FIG. 11A taken along the line 11B-11B, in accordance with various embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples of rotatable sluicing devices and methods related thereto for separating heavy particulate material from lower density substrates in ore. In accordance with various embodiments, a rotatable sluicing device may enable more continuous sluicing of ore that conventional systems, and provide an improved efficiency of operation. For example, conventional sluicing surfaces (e.g. sluice boxes, sluicing mats) typically require manual removal of trapped particulates, resulting in significant system down time and manual labour. While rotational sluices may mitigate these disadvantages to some degree, they may do so at the cost of a reduced efficiency in separation. For instance, United States Patent Application No. 2013/0181077 entitled “Concentrator Apparatus for Recovering Lead or Other Material” and published to Harris and Marks on Jul. 18, 2013 attempts to improve efficiency of a rotating sluice by varying a baffle height or spacing along the length of a rotating cylinder, or by tilting the baffle upstream. While such systems may improve a trapping efficiency for some applications, like separating lead shot from soil, the mechanism of recovery, namely the physical obstruction and subsequent trapping of particles on the upstream edge of the baffle, may not be well suited to trapping finer particles, such as those in which precious materials like gold are often found. Rather, such particulates may, in accordance with various embodiments herein disclosed, be more efficiently trapped using baffle configurations that allow for separation and concentration to occur downstream of the baffle, or in a riffle disposed relative to the baffle and configured to collect heavy particulates for transfer upstream upon device rotation.

Accordingly, various embodiments herein described may make reference to the separation of gold from ore. However, it will be appreciated that embodiments are not so limited, and that the term “ore”, as used herein, may also refer to other raw materials, such as dirt, soil, silt, rocks, running water and solid materials flowing therein (e.g. water and rocky materials from a streambed), or the like. Similarly, embodiments may relate to the separation or concentration of dense materials other than gold. For instance, an in accordance with various embodiments, a continuous sluicing system may be used to separate and concentrate other precious metals or other heavy particles, non-limiting examples of which may include lead, iron, or black sand.

In accordance with some embodiments, the systems and methods herein described provide for improvements over conventional rotating sluices via improved trapping configurations. Further, and in accordance with various embodiments, the systems and methods herein disclosed may enable high throughput of ore processing and separation through the combination a rotational sluice for continuous or near-continuous separation/concentration of materials, and a built-in trommel device for ore pre-processing or classification.

As is known in the art, paydirt is an inputted feedstock in the mining industry which contains the materials of interest and which one desires to recover. As termed herein, the materials of interest are also termed “recoverables”, and paydirt may be termed ore, in various portions of the description.

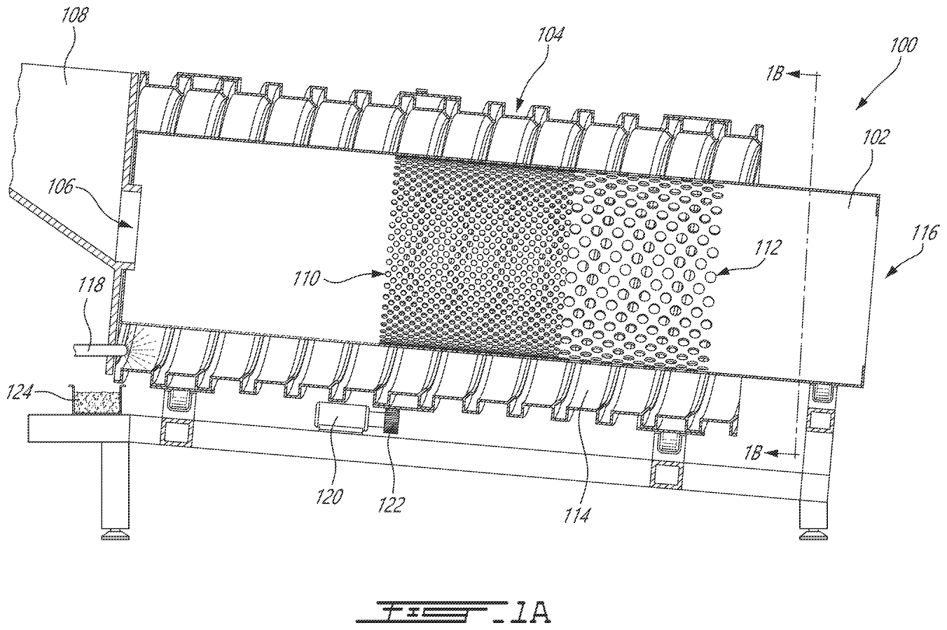

For example, and in accordance with various embodiments, FIG. 1A shows a cross-sectional left-side view of an illustrative rotational sluicing system 100, and FIG. 1B shows a front perspective sectional view of some elements of the system 100 taken along line 1B-1B of FIG. 1A. In this example, an inner trommel 102 is disposed substantially concentrically within an outer separating cylinder 104, also herein referred to interchangeably as a sluicing barrel. While the sluicing barrel 104 of FIG. 1 is substantially cylindrically shaped, it will be appreciated that various other substantially rotationally symmetric open-ended hollow bodied structures may be employed as a sluicing barrel 104 in a continuous rotating sluice 100. For instance, and without limitation, a sluicing barrel 104 may comprise a geometry that is substantially one or more of cylindrical, conical, strobilate, infundibular, hourglass-shaped, turbinate, ellipsoidal or shaped like an inverted double cone.

In this example, the upstream end region of the trommel 102 is configured to receive ore from an intake region 106. In some embodiments, the system 100 may further comprise an input reservoir 108, such as a hopper 108, a conveyor system as is known in the art (not shown), or other like feedstock infeeding system for providing ore-ladened material, or paydirt, into the trommel portion 102. Accordingly, an input reservoir 108 may enable addition of material in discreet amounts (e.g. buckets of stream water and streambed material, a scoop of ore from a shovel or tractor, a load from a dump truck, or the like), or in a continuous fashion (e.g. via a conveyor system). Some embodiments may further relate to an input reservoir 108 or infeed system comprising a water system, blades, or other pulverising units to assist in breaking up, de-lumping, or pre-separating ore for more efficient downstream processing. In accordance with some embodiments, the input reservoir 108 may further comprise a size limiting means such as a meshing or material sizing bars as is known in the art (not shown) to exclude material above a designated dimension from entering the trommel 102. For example, such size limiting means may be provided as a grating or bars spaced apart by a designated distance at the intake region 106 or elsewhere in the input reservoir 108.

In accordance with various embodiments, ore may be fed into the trommel for pre-classification, wherein ore introduced via the intake region 106 may first pass one or more classifying meshes. In the exemplary embodiment of FIGS. 1A and 1B, the trommel 102 comprises first and second classifying meshes (porous regions) 110 and 112 configured to selectively allow passage of only materials below respective threshold sizes. Particles below the respective threshold sizes, whether dry or mixed with water or another carrier fluid introduced into the trommel, may then fall onto the inner surface 114 of the separating cylinder 104, while particles or other bulk materials too large for passage may continue through the trommel 102 to be discharged from discharge end 116 thereof. Materials transferred from the trommel 102 to the outer cylinder 104 may then, in accordance with various embodiments, be further mixed with water or another carrier fluid to form a slurry for sluicing in the outer separating cylinder 104.

In accordance with different embodiments, a carrier fluid may be added to the system via a fluid inlet 118, which may comprise, for instance, a hose 118, one or more apertures in the outer cylinder 104 in fluid communication with a fluid reservoir and disposed to enable the addition of fluid into the outer cylinder 104, or the like. It will be appreciated that a fluid inlet may allow for addition of fluid into the system 100 at various inlet points. For instance, the fluid inlet may allow for the addition of water into the outer cylinder 102, as shown in FIG. 1A, into the trommel 104, or into the input reservoir 108. In one embodiment, the input reservoir 108 may itself comprise water and material from a streambed, either added by a user or flown directly into the trommel 102. Accordingly, the input reservoir 108 may, in one embodiment, comprise the fluid inlet 118. It will be appreciated that, in accordance with various embodiments, fluid may passively or actively be added to the system via a fluid inlet 118 at a designated or controllable flow rate, based on, for instance, operational conditions and/or system geometries, to provide a desired efficiency of particle separation and concentration.

It will be appreciated that various trommel configurations may be employed in a continuous sluicing system 100, in accordance with various embodiments. For instance, a trommel 102 may comprise any number of respective regions having respective classifying mesh sizes. For instance, and in accordance with different embodiments, a first sluicing application (e.g. sluicing stream water using a system portable in a backpack, or the like) may be enabled using a system 100 comprising a trommel 102 having only a single classifying mesh size, while a second sluicing application (e.g. an industrial scale stationary sluice for use at a mine site, a large-scale continuous sluice hauled by an 18-wheel truck, or the like) may be more efficiently enabled by a system 100 comprising a trommel 102 having 8 or more classifying mesh sizes. Furthermore, it will be appreciated that a classifying mesh region (e.g. meshes 110 or 112) may comprise various configurations, such as aperture arrangements/sizes (e.g. hexagonal arrays of small or large apertures, etc.), placements (e.g. upstream, downstream, relative placements of different classifying meshes, etc.), or sizes (e.g. aperture diameters, area of the trommel comprising apertures, etc.). For example, and in accordance with one embodiment, a trommel 102 may comprise a classifying mesh region comprising apertures 1 cm in diameter, wherein the mesh region occupies 10% of the trommel area in a downstream end of the trommel 102. In an alternative embodiment, the entire length of the trommel 102 may comprise porous region comprising apertures 0.5 cm in diameter.

In accordance with various embodiments, a trommel region 102 of a continuous sluicing system may be operably coupled with an outer separating cylinder 104 so to rotate synchronously therewith, as schematically illustrated in FIG. 1B. Accordingly, in such embodiments, both the trommel 102 and cylinder 104 may be driven to rotate 126 by a common drive means 120. For example, and in accordance with at least one embodiment, the continuous sluicing system 100 of FIG. 1A comprises a single drive means 120 operable to rotate the outer cylinder 104, and by way of a physical connection 128, simultaneously rotate the trommel 102. In accordance with various embodiments, various coupling means 128 may be employed to simultaneously rotate both the trommel 102 and cylinder 104. For example, portions of the trommel 102 may be coupled to the cylinder 104 via one or more posts 128 or other connections 128 (e.g. plates, metal surfaces, etc.) near one or more of the intake region 106 and discharge end 116 of the trommel, or at locations therebetween, to enable synchronous rotation thereof.

In the exemplary embodiment of FIG. 1A, the drive means 120 (e.g. a motor) is coupled to the outer cylinder 104 via a gear assembly 122. The skilled artisan will appreciate that the outer surface of the cylinder 104 may therefore comprise, in some embodiments, a means of coupling to the gear assembly 122, such as grooves or teeth complementary to the gear assembly 122. Further, the gear assembly 122 may comprise a single gear, a plurality or combination of gears, or the like, and may further be configured such that a user may select a gear or gear ratio depending on, for instance, a desired speed of rotation. Similarly, the drive means 120 may be configurable to output one or more rotational speeds or powers with which to rotate the cylinder 104.

Additional gears may further be employed to provide a physical connection 128 between the outer cylinder 104 and the trommel 102. For instance, and in accordance with one embodiment, a combination of gears may connect the cylinder 104 and trommel 102 so to enable respective rotation speeds thereof from a common drive means 120. It will be appreciated that a drive means 120 may alternatively be coupled directly to the trommel 102 rather than the outer cylinder 104. For example, the drive means 120 may first rotate 126 the trommel 102 at a first high speed to facilitate breakup and classification of ore, which, via a gear combination coupling the trommel 102 with the outer cylinder 104, causes the outer cylinder 104 to rotate at a second slower speed for particle separation and concentration. In will further be appreciated that various embodiments relate to a trommel 102 and outer cylinder 104 having respective drive means, wherein each component may rotate at a respective designated or optimal angular speed for their respective purposes. Naturally, such embodiments may relate to configurations in which the trommel 102 and cylinder 104 are not coupled via direct physical connections 128 for synchronous rotation. It will further be appreciated that a drive means 120 may be coupled at various locations on the outer cylinder 104. For instance, rotation 126 of the outer cylinder 104 may be enabled via coupling at one or more ends thereof to the drive means 120, or at one or more locations therebetween. In some embodiments, the drive means 120 may additionally or alternatively be coupled to an inner surface of the outer cylinder 104 configured to mate therewith. In yet another embodiment, the drive means 120 may simultaneously rotate 126 both the outer cylinder 104 and an inner trommel 102 via a gear assembly 122 in rotatable communication with both an inner surface of the outer cylinder 104 and an outer surface of the trommel 102.

In accordance with other embodiments, the drive means 120 may comprise alternative configurations for rotating the cylinder 104 and/or trommel 102. For instance, a drive means 120 may be coupled to the outer cylinder 104 via one or more belts, pulleys, chains, or the like, rather than a gear assembly 122. In yet other embodiments, rotation 126 may be enabled via a manual drive means (e.g. a hand crank), or other means known in the art for imparting rotation to one or more components of the system 100.

Upon rotation 126 of the outer cylinder 104 via the drive means 120, and as will be described in further detail below, dense materials in the outer cylinder 104 will gradually be transported upstream. Upon reaching the upstream end of the cylinder 102, particles may be automatically discharged into a collection reservoir 124 comprising, for instance, a bucket, a fine screen, a bag, or the like. Accordingly, such automatic removal of trapped material from the rotating cylinder 104 may preclude the shutdown of the system 100 required in conventional sluicing systems to extract valuable materials. The rotating sluice system 100 may therefore be operated continuously or near-continuously for improved system efficiency and reduced manual labour requirements.

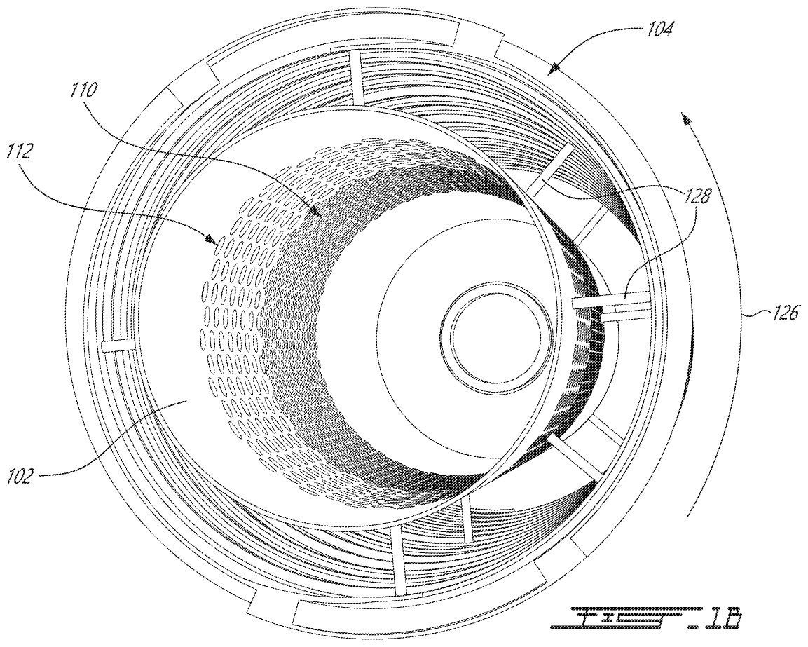

With reference now to FIGS. 2 to 4, and in accordance with some embodiments, an exemplary configuration of an outer separating cylinder 102 and an associated exemplary mode of operation will now be described. In this non-limiting example, FIG. 2 shows a top-left-side perspective view of the outer cylinder 104 of FIG. 1A, FIG. 3 is a cross-sectional view of the outer cylinder 104 taken along line 3 of FIG. 2, and FIG. 4 is a zoomed schematic of the portion of the cylinder 104 indicated by the box 4-4 of FIG. 3 during system operation.

As illustratively shown in FIG. 3, an outer cylinder 104 may comprise one or more helical collection riffles 302. In accordance with various embodiments, a collection riffle 302 may be continuous along the inner surface 114 of the separating cylinder 104 (i.e. a single helical riffle along the length of the cylinder 104), or it may comprise a plurality of individual riffles. For example, as shown FIGS. 1A to 4, cylinder 104 comprises two helical riffles 302a and 302b on the inner surface 114, as indicated on FIG. 3. The riffles 302a and 302b, in this example, are alternating from left to right in the cross-sectional view of FIG. 3 along the length of the cylinder 104, with each helix characterised by a pitch 304. Accordingly, various embodiments relate to cylinders 104 comprising various numbers of helical riffles 302 based on, for instance, a desired longitudinal spacing 306 between adjacent riffles along the inner surface 114 of the cylinder 104, manufacturing limitations with respect to helical pitch angles 308 (i.e. number of rotation per unit length of the cylinder 104) and cylinder diameter 310, operational conditions (e.g. angular speed of rotation 212, sizes of particles to be separated, flow rates, etc.), or the like. For example, and without limitation, it may be preferred that the outer cylinder comprises a longitudinal spacing 306 between adjacent riffles that is four times smaller than what may be manufactured in view of an accessible pitch angle 308 and the outer cylinder diameter 310. In accordance with such an embodiment, an outer cylinder 104 may comprise four individual helical collection riffles, each having a pitch 304 that is four times the adjacent longitudinal spacing 306 between riffles in the longitudinal direction. Conversely, and in accordance with another embodiment, it may be preferred, based on, for instance, the relative sizes of materials to be separated and a speed of material flow downstream during use, that an outer cylinder comprises a single helical collection riffle along the length of the inner surface 114, wherein the helical pitch 304 is equal to the longitudinal spacing 306 between adjacent riffles in a corresponding cross-sectional view.

In accordance with various embodiments, the inner surface 114 of the outer cylinder 104 may comprise spiral fighting 312 near or adjacent to a corresponding helical collection riffle 302. Accordingly, and in accordance with various embodiments, spiral flighting 312 may comprise any number of individual spiral flights, each associated with a respective collection riffle 302. For example, and without limitation, the outer cylinder 104 of FIG. 3 comprises two distinct spiral flights 312a and 312b corresponding to, respectively, helical collection riffles 302a and 302b. In accordance with various embodiments, spiral fighting 312 may comprise various geometries, non-limiting examples of which are further described below. It will further be appreciated that while spiral flighting 312 in FIGS. 1A to 4 is immediately adjacent to and along an edge of collection riffle 302 (i.e. disposed on and along an edge of the helical collection riffle 302), that different embodiments herein contemplated comprise a gap therebetween (i.e. the helical fighting 312 follows an edge of the collection riffle 302, but is separated therefrom by a designated longitudinal distance). In yet further embodiments, the collection riffle 302 may be omitted from the system shown in FIGS. 1A to 4, with the particular designated configuration of the spiral fighting 312 providing sufficient means for separating heavy particulates from raw substrates and transferring recoverables upstream. Accordingly, while the following description relates to embodiments comprising both a helical collection riffle 302 and spiral fighting 312, it will be understood that other embodiments relate to similar systems comprising the spiral flighting 312, but not the helical collection riffle 302. In yet other embodiments, additional flighting configurations may be disposed on the inner surface 114. For instance, and in accordance with one embodiment, a collection riffle 302 may have both a corresponding upstream flight 312 and a down stream flight (i.e. a flight 312 on either side of the collection riffle 302). In another embodiment, a series of flights (e.g. 4 flights) may be disposed upstream of a corresponding collection riffle.

With reference now to FIG. 4, and in accordance with various embodiments, a mode of operation of a continuous rotating sluice, generally referred to with the numeral 400, will now be described. In this illustrative example, the outer cylinder 104 is disposed such that any particulate material passing through porous regions of a trommel 102 will fall on an inner surface 114 of the cylinder 102. In accordance with various embodiments, the particulate material at this stage or operation may already be mixed with water or another carrying liquid. For instance, buckets of stream water and solid materials from a streambed, or a continuous stream of water and a supply of paydirt, may be have been added to the intake region 106 of the trommel 112, or both dry ore and a carrier fluid may have been added to the trommel 102 for pre-mixing. In accordance with other embodiments, particulates transferred from the trommel 102 to the outer cylinder 104 may be then mixed with a carrier fluid from, for instance, a fluid inlet 118, to form a slurry for sluicing.

In either case, the slurry may then flow along the inner surface 114 of the outer cylinder 104 in a downstream direction, as schematically illustrated by flow line 402. In the configuration of FIG. 4, slurry following the flow line 402 may generally flow downstream along the surface 114 before encountering a spiral fighting 312, whereby the direction of flow may change to generally follow flighting 312 extending inwardly and downstream from the cylinder surface 114. Based in part on the system geometry and the fluidic and gravitational forces at play in the system, dense particles immediately downstream of the flighting 312 may then fall downwards for collection in the collection riffle 302, schematically shown by sediment 404 in FIG. 4. Conversely, lighter, less dense, or larger particles in the slurry may continue along with flow 402, ultimately to be discharged from the cylinder 104 at a discharge end thereof.

As the cylinder 102 rotates, sediment 404 trapped in the riffle 302 will gradually be transported 406 upstream (for eventual egress to a collection reservoir 124) against the general direction of flow 402, in accordance with the helical geometries of the system components. Based on the configuration of the fighting 312, and, in this example, the adjacent collection riffle 302 downstream thereof, fluid forces may be tuned (e.g. via fluid flow rates, rates of rotation 212 of the cylinder 104, relative amount of particulate matter in the slurry, tilt of the cylinder 104 relative to horizontal, or the like) to improve trapping efficiency of recoverables 404 downstream of spiral fighting 302, while minimising trapping of bulk ore material. In comparison with conventional rotating sluice devices, such as that of United States Patent Application No. 2013/0181077 that relies on particles being trapped upstream of a baffle as described above, various embodiments herein described therefore relate to a continuous sluicing system that accumulates valuable materials downstream of a fighting for improved concentration ability and efficiency. Further, while FIG. 4 schematically illustrates sediment accumulation 404 in a helical collection riffle 302, it will be understood that various fighting configurations, non-limiting examples of which will be described below, may enable accumulation of particulates 404 downstream of the flighting for transport upstream 406 upon rotation of the outer cylinder 104, for instance by providing different flow regimes 402 that urge denser particulates in an upstream direction (i.e. towards the downstream side of spiral fighting 312) near the surface 114 of the outer cylinder. In accordance with other embodiments, the spiral flighting 312 may be disposed downstream of the helical collection riffle 302, wherein the flow pattern 402 arising from the particular configuration of both the individual and collective effects of the flighting 312 and riffle 302 allow for separations of dense particulates 404 and transport 406 upstream.

Various alternate outer cylinder 104 configurations are herein contemplated. For example, outer cylinders, in accordance with various embodiments, may comprise application-specific diameters and/or lengths. For instance, continuous sluices for hobbyists may comprise outer cylinders having diameters between 6 and 24 inches, and be less than 4 feet in length for easy transport. In alternative embodiments, continuous sluices for industrial use may comprise cylinders having diameters of over 10 feet and lengths of up to tens of meters. Similarly, various embodiments relate to sluices having any number of helical turns of collection riffles and/or fighting. For example, and in accordance with one embodiment, an outer cylinder may comprise a spiral flight configured to provide 10 turns per longitudinal inch of an outer cylinder (i.e. a spiral flight having a pitch of 0.1 inches). In another embodiment, the pitch of a spiral flight and a corresponding helical collection riffle may be 2 metres. The skilled artisan will appreciate that cylinders comprising multiple helical structures may comprise inter-helical distances longitudinally along an inner cylinder surface that are smaller than the nominal pitch of an individual helix, as described above.

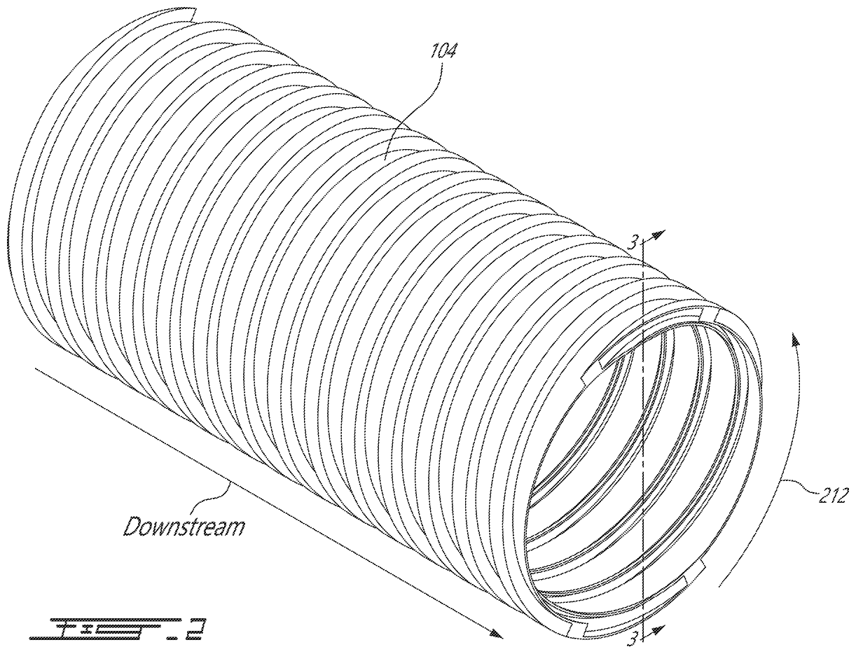

Outer cylinders may further comprise various configurations of helical collection riffles and/or fighting. For example, and in accordance with another embodiment, FIG. 5A is a top-left-side perspective view of an exemplary outer cylinder 500, and FIG. 5B is a cross-sectional view of the cylinder 500 taken along the line 5B-5B of FIG. 5A. The outer cylinder 500 again comprises spiral fighting 502 similar to that of FIGS. 1A to 4, but in this example, the helical collection riffle 504 comprises a rounded topology. This rounded configuration may be preferred, in accordance with some embodiments, for ease of manufacture using, for instance, rifling or threading techniques known in the art. Similarly, and in accordance with some embodiments, spiral flighting may similarly be machined directly into a surface 506 of the outer cylinder 500. Accordingly, such embodiments may further relate to an outer cylinder 500 comprising a material or surface 506 that is amenable to such rifling, threading, or other machining techniques (e.g. milling, CNC machining, etc.), such as a metal, alloy, polymer, or the like. In alternative embodiments, the cylinder 500 may be manufactured by other processes, and accordingly comprise alternative materials. For instance, the outer cylinder 500, or other embodiments of outer cylinders, non-limiting examples of which are herein described, may be formed via injection moulding, extrusion, or other processes known in the art for forming rigid structures of designated geometries. Accordingly, an outer cylinder 500 may comprise materials such as plastics, polymers, or metals amenable to such processes, and may, in accordance with some embodiments, comprise a monolithic structure.

Conversely, and in accordance with another embodiment, FIG. 6A shows a top-left-side perspective view of an exemplary outer cylinder 600 comprising more than one component, and FIG. 6B shows a cross-sectional view of the cylinder 600 taken along the line 6B-6B of FIG. 6A. The outer cylinder 600 again comprises a rounded helical collection riffle 604 similar to riffle 504 of FIGS. 5A and 5B, but, in this example, spiral fighting 602 comprises a structure distinct from the rest of the cylinder 600. The flighting 602 may comprise, for instance, an attachment that may be added to the inner surface 606 of the outer cylinder. In accordance with various embodiments, the fighting structure 602 may be coupled with the inner surface 606 at a junction 608 via various means known in the art, non-limiting examples of which may include welding, soldering, or the use of an adhesive. Such embodiments may be preferred if, for instance, injection moulding or machining monolithic structures presents challenges in manufacture or cost, or if the desired materials for the outer cylinder 600 and/or spiral fighting is not amenable to such processes. It will be appreciated that while the junction 608 at which spiral fighting 602 is coupled with the inner surface 606 of the outer cylinder 600 is schematically depicted as an irreversible coupling comprising, for instance, a weld or solder, various other embodiments relate to other means reversibly coupling spiral fighting 602 to the inner surface 606, such as through the use of screws, bolts, rivets, or the like.

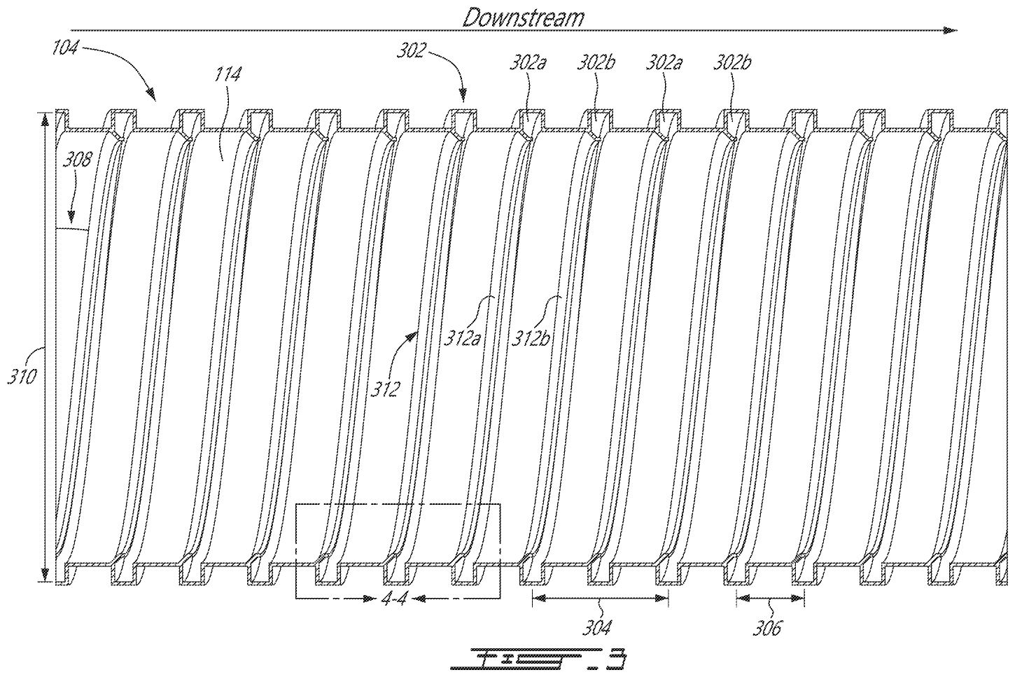

For example, and in accordance with another embodiment, FIG. 7 schematically shows a partial cross-sectional view of various components of an outer cylinder 700 in which spiral flighting 702 is fastened to the inner surface 704 of the cylinder 700 via bolts 706, screws 706, rivets 706, or other like means. In accordance with various embodiments, the spiral fighting may comprise more than one segment. For example, the spiral flighting configuration shown in FIG. 7 comprises three segments. As the fighting 702 comprises a generally three-dimensional spiral configuration about an axis, each segment in turn comprises a corresponding three-dimensional geometry about that axis. Accordingly, while the following description relates to a two-dimensional cross section of the fighting 702 for simplicity, as schematically depicted in FIG. 7, it will be appreciated that the structures described comprise three-dimensional structures that similarly comprise a rotational axis corresponding to that of the outer cylinder 700.

The first segment 708 of the spiral fighting of FIG. 7 comprises a substantially flat region 708 that may lie approximately flush with the inner surface 704 of the separating cylinder 700. In accordance with different embodiments, the first segment 708, or anchoring portion 708, may be coupled with the cylinder 700 using bolts 706 or rivets 706 passing therethrough, as shown in FIG. 7, or it may be fastened to the inner surface 704 via screws, welds, or other like means. It will be appreciated that other fastening means known in the art may be employed to permanently or reversibly couple the fighting 702 to the inner surface of the separating cylinder 704, in accordance with various other embodiments. The second fighting segment 710, also herein referred to as a “baffling portion” 710, extends, in this exemplary embodiment, inwardly and at a designated angle 712 from the inner surface 704 of the outer separating cylinder 700. In accordance with various embodiments, the angle 712 formed between the baffling portion and the inner surface 704 may selected based on, for instance, the desired sluicing application and/or operating conditions. For instance, and in accordance with various embodiments, the designated angle 712 may comprise an angle between 5 degrees and 90 degrees (wherein 0 degrees would comprise the baffling portion 710 lying along the inner surface 704 and pointed downstream). In accordance with another embodiment, the angle 712 may be 90 degrees, wherein the baffling portion 710 extends radially inwardly from the inner surface 704. In yet other embodiments, the baffling portion 710 may be configured to form an angle between 90 degrees and 180 degrees (i.e. angled upstream). In this exemplary embodiment, the spiral flighting 702 further comprises a third portion 714, also herein referred to as a “fighting portion” 714. In accordance with various embodiments, the fighting portion 714 may extend substantially downstream (i.e. towards a discharge end of the cylinder 700), as shown in FIG. 7, or may extend at another designated angle with respect to either the inner surface 704 or to the baffling portion 710. In accordance with other embodiments, the fighting portion may comprise alternate configurations, as described below, which may omit one or more of the fighting portion, baffling portion, or, in embodiments in which the fighting 702 is welded or soldered to the inner surface 704 or if the fighting 702 is a component of the surface 702 itself, the anchoring portion. It will further be appreciated that various lengths, angular orientations (e.g. angle 712), or the like, may vary, for instance along a longitudinal length of the separating cylinder 700. For example, and in accordance with one embodiment, the angle 712 between the baffling portion 710 and the inner surface 704 may begin at a first angle 712 (e.g. 30 degrees) at an upstream end of the cylinder 700, and gradually increase to a second angle (e.g. 150 degrees) at a downstream end of the cylinder 700.

In the exemplary embodiment of FIG. 7, the outer cylinder 700 comprises an exemplary triangular collection riffle 716 disposed at designated distance 718 from the base of the spiral fighting 702. In this example, the distance 718 between the fighting 702 and the riffle 716 is such that the flighting portion 714 extends above the riffle 716. It will be appreciated that various embodiments relate to alternate configurations in which the distance 718 is greater or less than that shown in FIG. 7, In accordance with some embodiments, the spacing may such that the collection riffle is significantly more downstream (e.g. no overlap of the flighting 702 and riffle 716) based on, for instance, the particular flow velocities or substrates employed in a sluicing application. Conversely, and in accordance with other embodiments, one or more regions of the fighting 702 may overlap with the collection riffle to a greater extent than shown in FIG. 7.

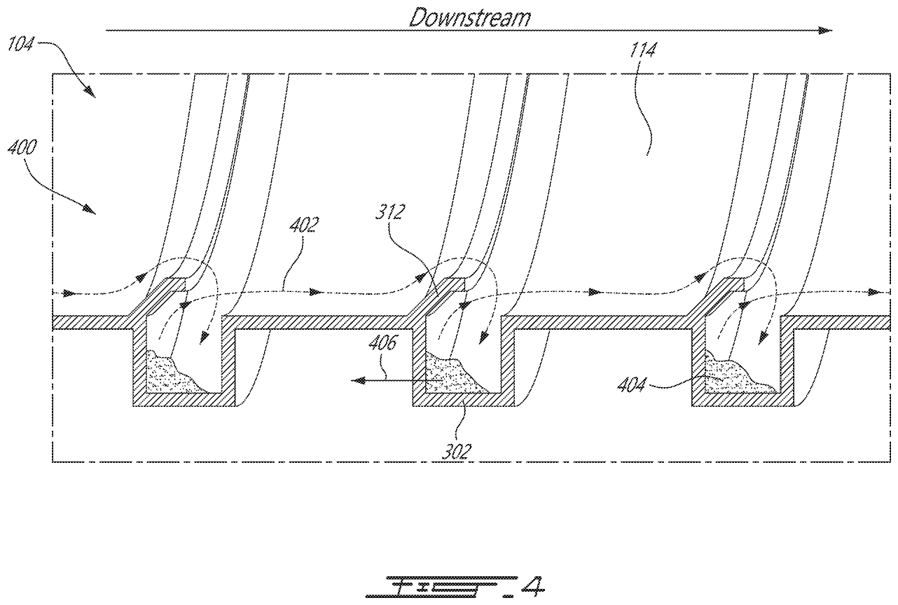

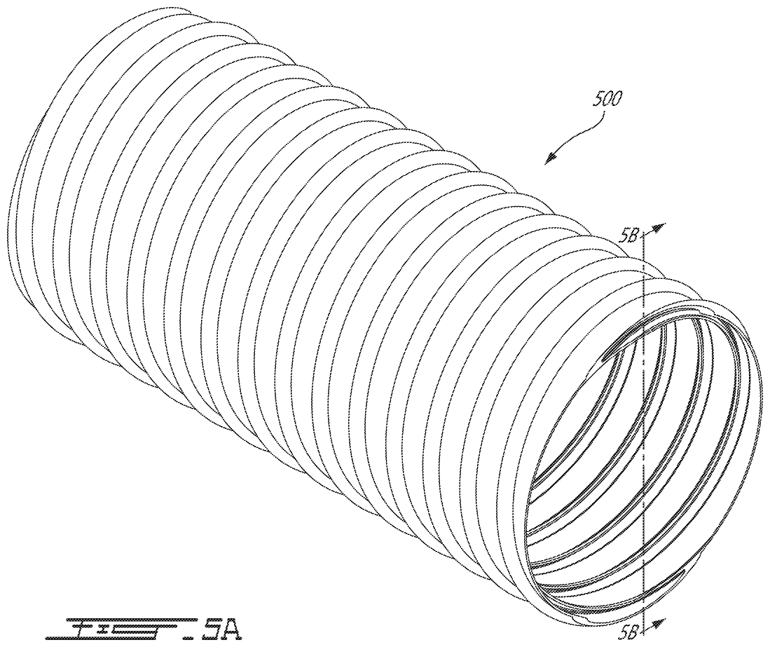

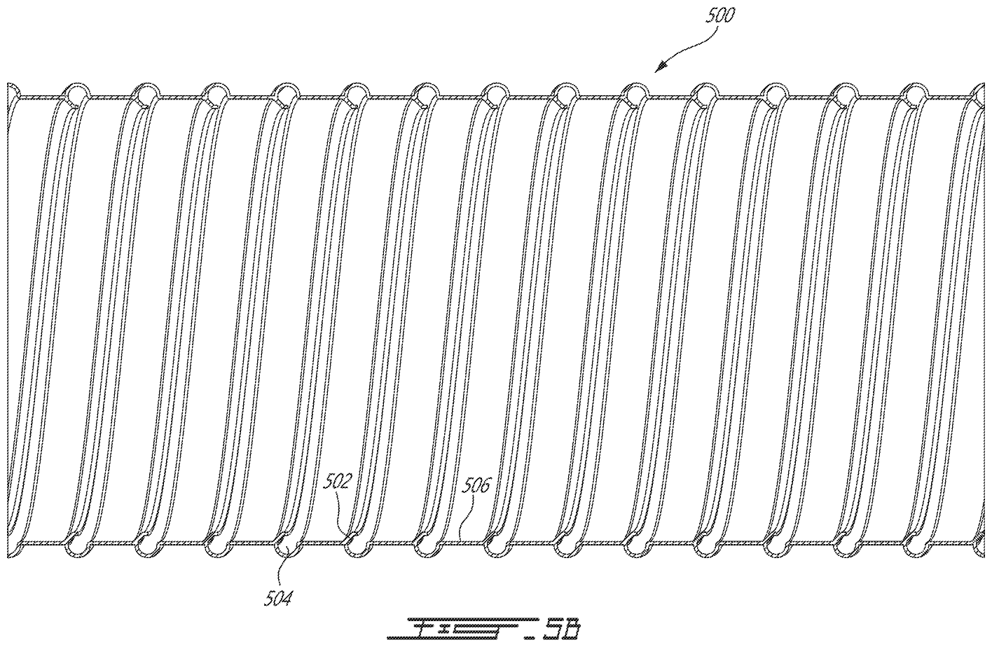

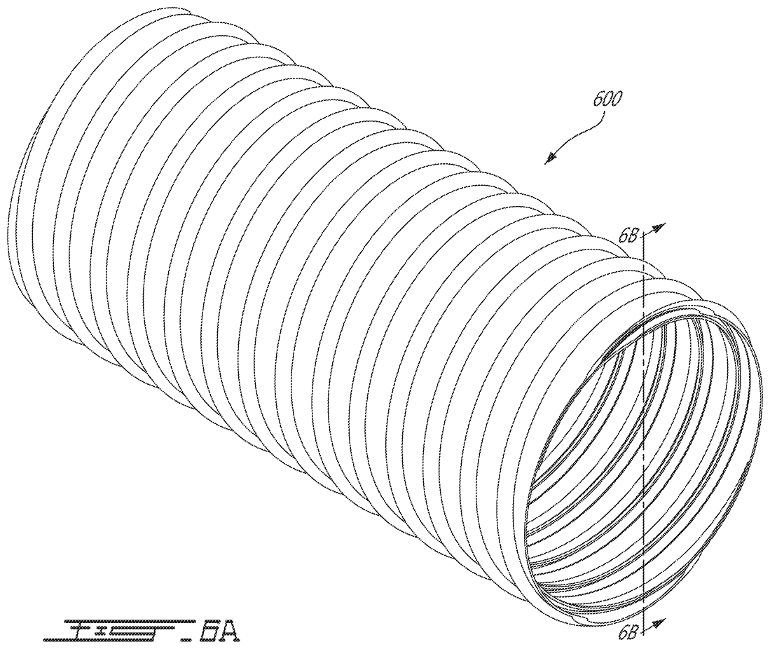

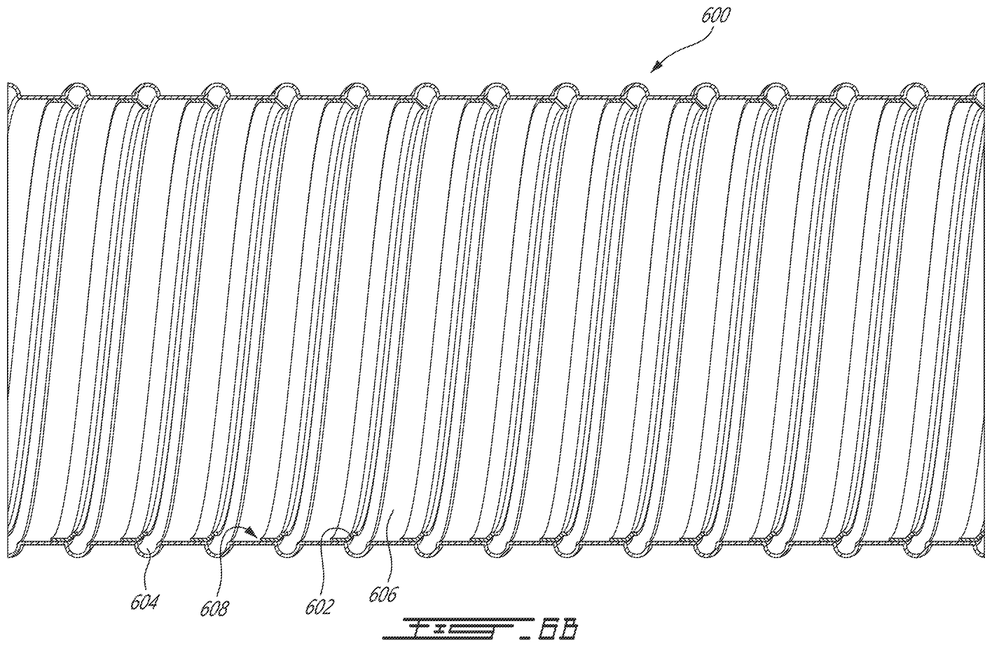

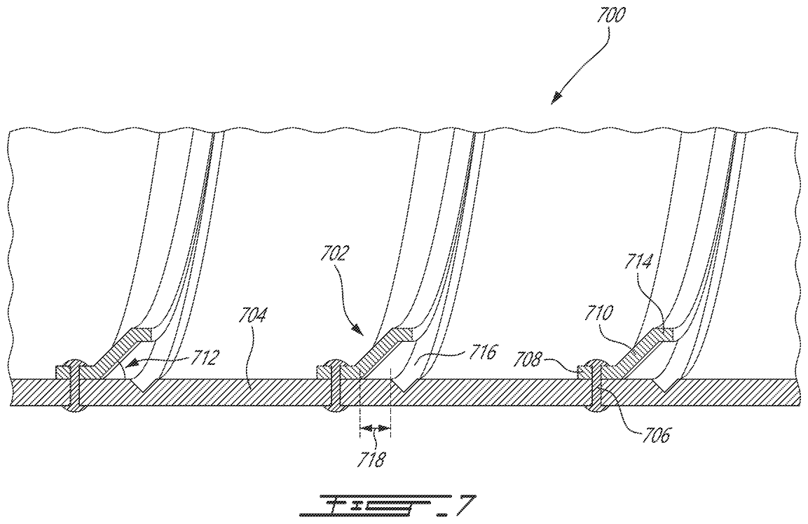

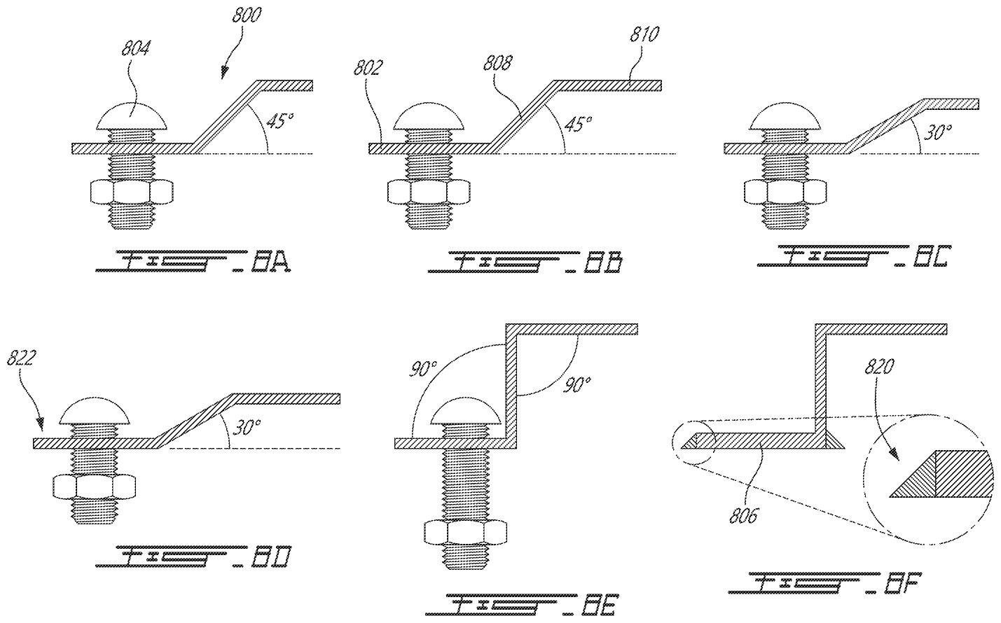

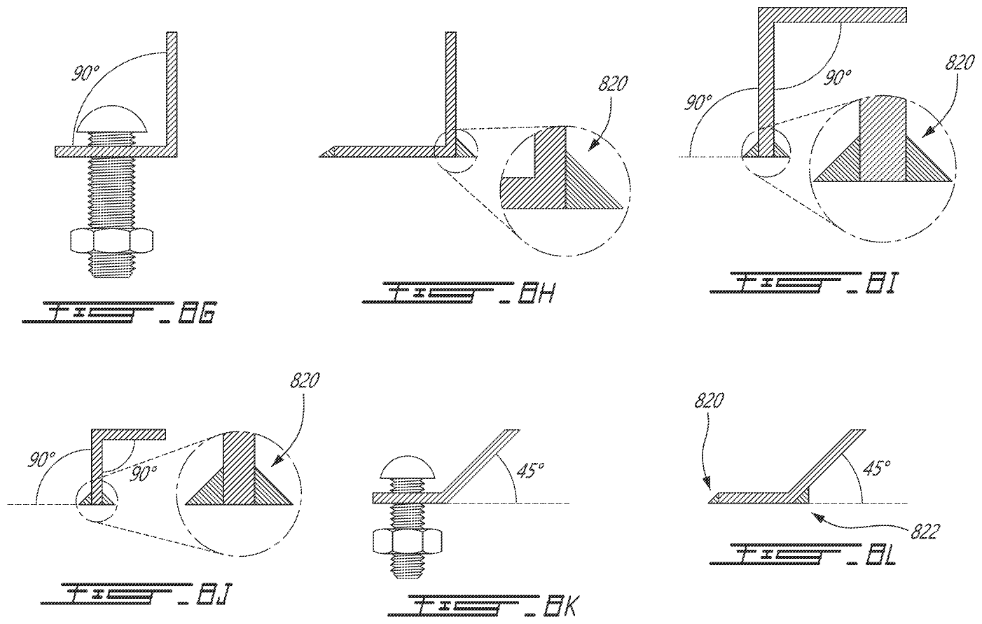

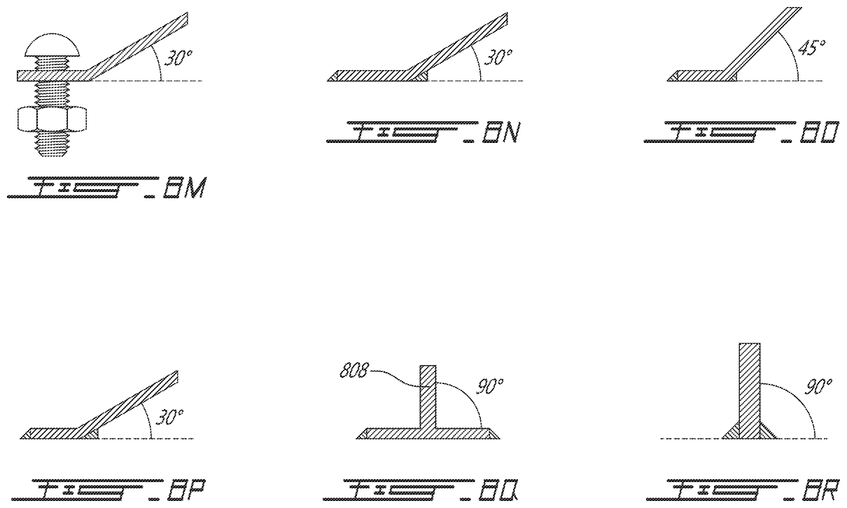

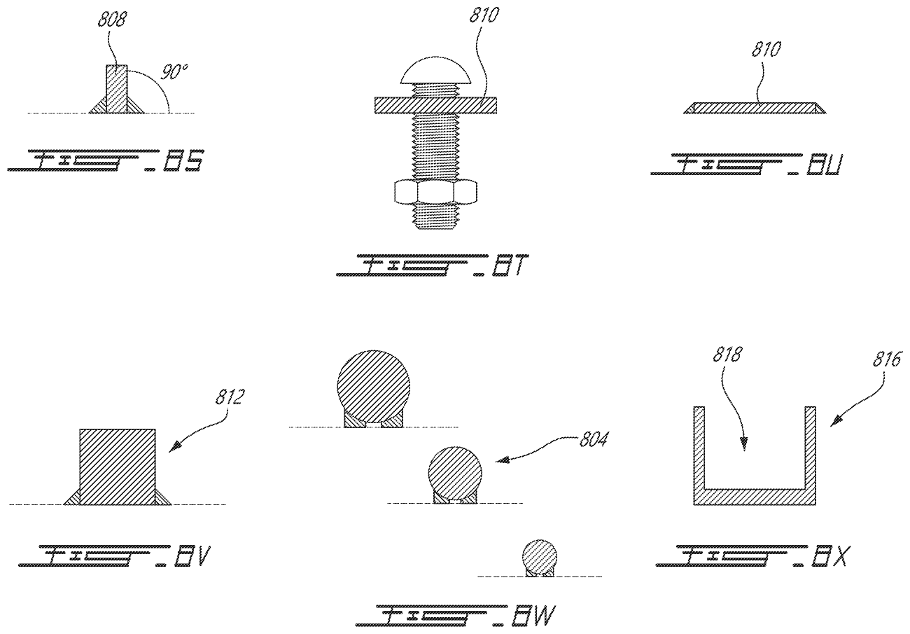

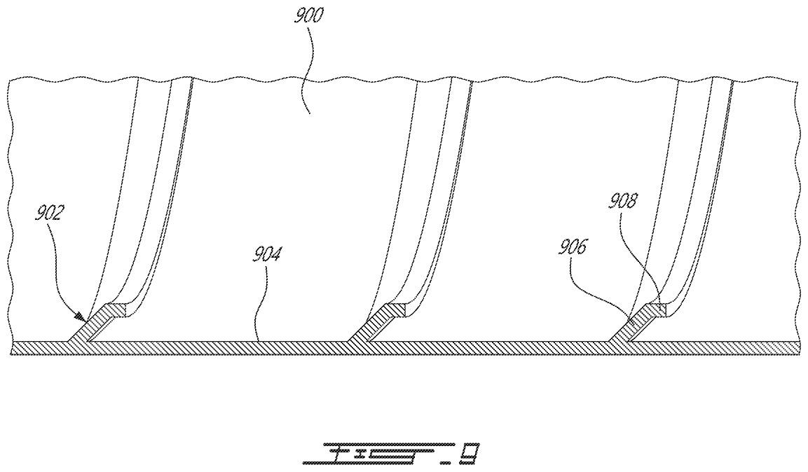

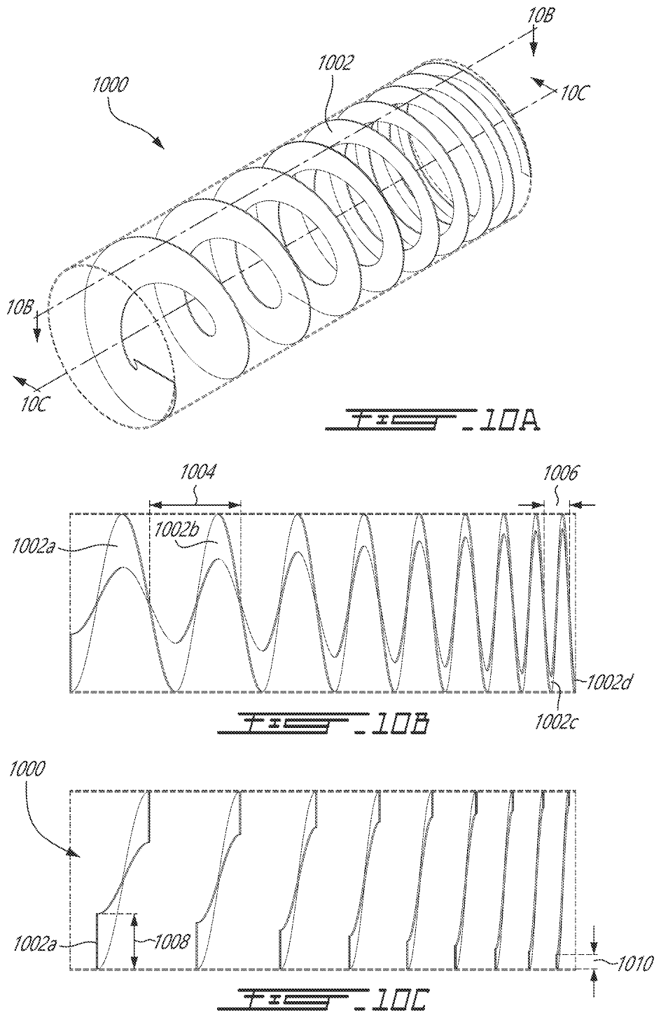

In accordance with yet other embodiments, spiral flighting 702 may comprise alternate configurations, which may, as described above, be fastened to the inner surface of a sluicing barrel in accordance with various means. Non-limiting examples of such configurations will now be described with reference to FIGS. 8A to 8X.

In some embodiments, spiral fighting 800 may comprise three segments, as described above and schematically shown in FIGS. 8A to 8F. In such configurations, an anchoring portion 802 may be anchored to the inner surface of a sluicing barrel via screws 804, bolts 804, or rivets 804 (FIG. 8A to 8E), or via a weld 806 or solder 806 (FIG. 8F). In accordance with different embodiments, a baffling portion 808 may extend at various angles relative to the inner surface of the sluicing barrel. For example, and without limitation, the baffling portion 808 may extend from the surface at an angle of 45 degrees (FIGS. 8A and 8B), 30 degrees (FIGS. 8C and 8D), or 90 degrees (FIGS. 8E and 8F). Further, various flighting segments may comprise different lengths. For instance, the flighting portions 810 of FIGS. 8A and 8C are shorter than the corresponding flighting portions 810 in, respectively, FIGS. 8B and 8C. Similarly, different embodiments relate to different lengths of baffling portions 808.

In alternative embodiments, spiral fighting may comprise two fighting components, as schematically illustrated in FIGS. 8G to 8Q. In these examples, anchoring portions 802 may again be bolted (e.g. FIG. 8G, 8K, or 8M) or welded (e.g. FIG. 8H to 8J, 8L, or 8M to 8Q) to the sluicing barrel, and may comprise various angles of baffling portions 808 relative to a barrel surface, non-limiting examples of which may include 45 degrees (e.g. FIG. 8K, 8L, or 8O), 30 degrees (e.g. FIG. 8M, 8N, or 8P), or 90 degrees (FIG. 8G or 8H). In some embodiments, such as those shown in FIGS. 8I and 8J, the baffling portion 808 may be welded directly to the inner cylinder, while a flighting portion 810 extends from a distal end thereof. While the examples of FIGS. 8I and 8J comprise two 90-degree angles in flighting configurations 800 of different sizes, it will be appreciated that various other angles may be provided, in accordance with different embodiments. In accordance with yet another embodiment, the baffling portion 808 may extend outwardly from the middle of the anchoring region 802, as shown in FIG. 8Q.

It will further be appreciated that various fighting segments may comprise different lengths, in accordance with various embodiments. For instance, FIGS. 8O and 8P schematically show spiral flighting 800 comprising shorter anchoring regions 802 than that in FIGS. 8G to 8N. Further, it will be appreciated that various embodiments relate to a fastening means that are appropriate for a particular fighting configuration. In the examples of FIGS. 8O and 8P, it may be preferred that fighting 800 is welded or soldered, for example if there is insufficient anchoring portion 802 length to adequately anchor flighting to a sluicing barrel via a bolt 804 or rivet 804. Similarly, the fighting 800 of FIG. 8Q may be preferentially anchored via welding 806 or a rivet 804, but not using bolts.

In accordance with other embodiments, a spiral flighting 800 may comprise a single segment for disrupting flow and/or forming desirable flow profiles in a sluicing barrel. For instance, FIGS. 8R and 8S illustrate embodiments in which various lengths of a flat baffling portion 808 (e.g. steel plates) are welded directly to the inner surface of the sluicing barrel. While the embodiments of FIGS. 8R and 8S relate to steel plates being welded at an angle of 90 degrees with respect to the barrel, various other embodiments relate to other angles (e.g. 30 degrees to 150 degrees).

In accordance with other embodiments, a single piece of fighting 810 (e.g. steel plates) may be bolted (FIG. 8T) or welded (FIG. 8U) directly to the sluicing barrel to provide flow lines appropriate for particle separation and/or concentration. In yet other embodiments, various other substrate materials may be directly bonded to the sluicing barrel. For instance, FIG. 8V schematically illustrates square steel rods 812 of various sizes that may be coupled with the barrel, for instance via a continuous weld. FIG. 8W to shows a similar embodiment in which a round steel rod provides a spiral flighting upon a continuous welding to the barrel. In accordance with yet another embodiment, FIG. 8X schematically illustrates a “U-shaped” channel which may be attached by, for instance, any of the means herein described. In accordance with such embodiments, the hollow region 818 of the channel 816 may comprise or constitute a collection riffle.

It will be appreciated that in addition to various fighting configurations provided by different numbers and orientations of segments, that various fighting segments may also comprises various geometries, in accordance with various embodiments. For instance, the insets of FIGS. 8F and 8H to 8I show anchoring regions 802 comprising tapered end portions 820, while the anchoring regions of, for instance, FIGS. 8A to 8D comprise flat end portions. Such configurations may be provided to, for instance, provide a designated flow profile of an above-passing flow, or to provide a more appropriate base surface for coupling (e.g. welding) to the inner surface of a sluicing barrel. Further, it will be appreciated that such coupling means (e.g. welds) may be provided based on, for instance, the configuration of the flighting 800. For instance, while it may be preferred that the flighting 800 of FIGS. 8I and 8J be welded to the barrel with a continuous weld, the flighting 800 of FIG. 8L may be coupled via a partial weld, or using spot welding processes.

It will be appreciated that while various embodiments of flighting configurations 800 have been described in FIGS. 8A to 8X with reference to various means of coupling with a sluicing barrel, various embodiments may relate to fighting that is inherent in the geometry of a monolithic sluicing barrel, as described above. For instance, FIG. 9 schematically illustrates one such embodiment, wherein spiral flighting 902 extends directly from the inner surface 904 of the sluicing barrel 900. Further, while the exemplary embodiment of FIG. 9 comprises fighting 902, it, and various other embodiments, relate to a sluicing barrel 900 that provides efficient separation and/or concentration of particulates without a helical collection riffle.

While the configuration of baffling 906 and fighting 908 portions shown FIG. 9 corresponds to that of FIG. 8A, it will be appreciated that other configurations of integrally formed flighting 902 may be provided, non-limiting examples of which are provided in FIGS. 8B to 8X. Indeed, it will be understood that any spiral flighting herein described or shown in the Figures may comprise any one or more of such configurations, without departing from the general scope or nature of the disclosure.

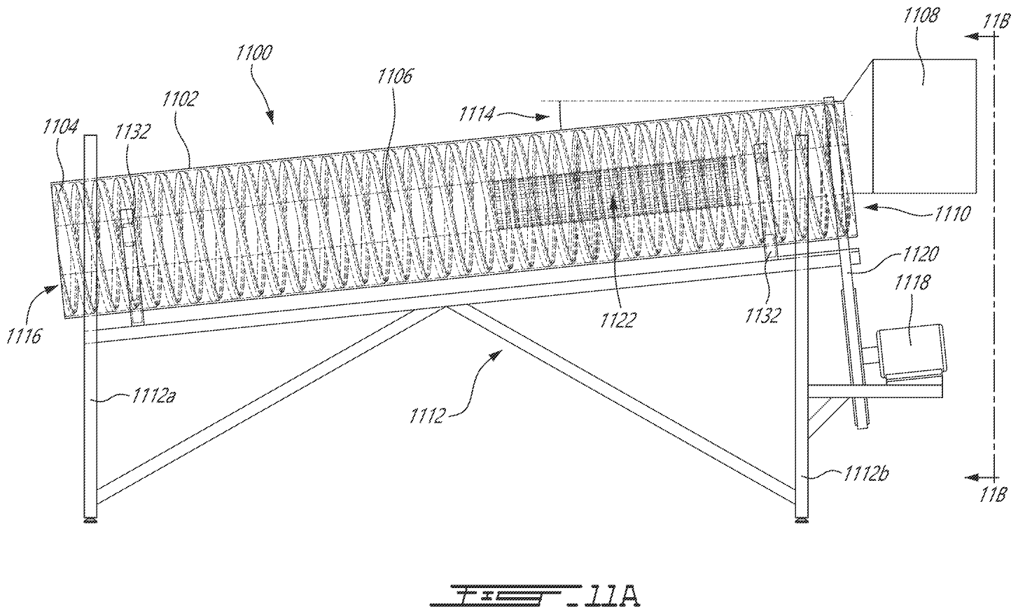

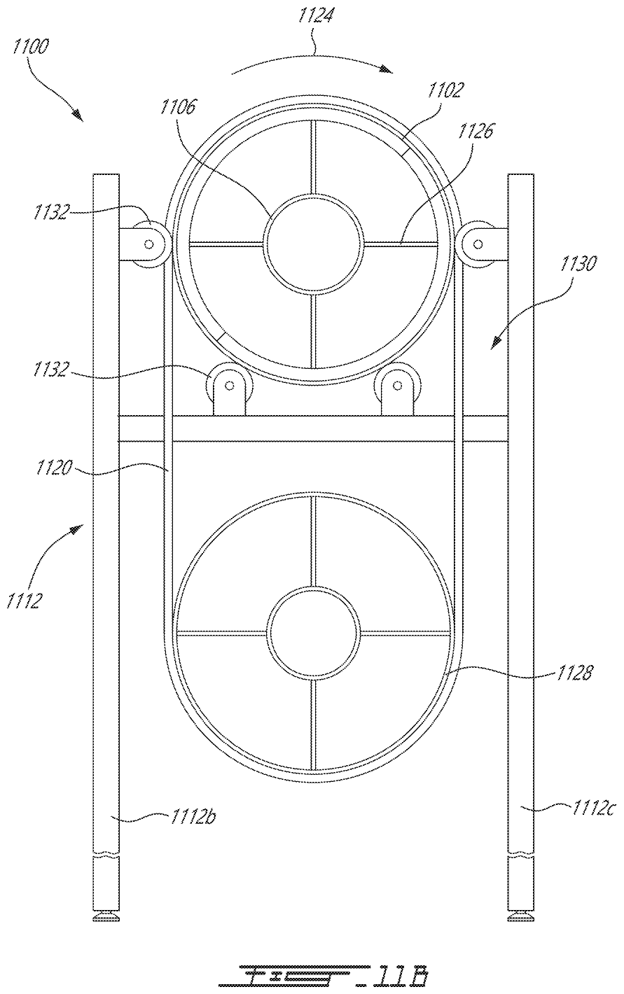

Accordingly, FIGS. 10A to 10C schematically show a sluicing barrel 1000 comprising a generalised fighting 1002 which will be understood to represent any one or more fighting configurations. In this example, and in accordance with various embodiments, flighting 1002 may comprise varying heights or spacing along the length of the barrel 1000. For instance, FIG. 10B showing a cross-sectional view of the barrel 1000 and fighting 1002 taken along the line 10B-10B of FIG. 10A. In this example, the spacing between flights decreases from left to right. That is, the spacing 1004 between adjacent flighting sections 1002a and 1002b on the left of the barrel is greater than the spacing 1006 between adjacent fighting sections 1002c and 1102d on the right of the barrel.

Similarly, FIG. 10C, showing a partial cross-sectional view of the base of barrel 1000 taken along the line 10C-10C of FIG. 10A, schematically illustrates decreasing height of fighting 1002 from left to right along the length of the barrel 1000. In this example the fighting section 1002a comprises a height 1008 that is greater than the height 1010 of the fighting section 1002d.

It will be appreciated that while the flighting 1002 of FIGS. 10A to 10C varies continuously in height and longitudinal separation along the length of the barrel 1000, various other embodiments relate to discreet changes in height and/or separation. For instance, a barrel 1000 may comprise segmented flights (e.g. three flights, one corresponding to the upstream portion of the barrel, one corresponding to the downstream portion of the barrel, and the other corresponding to the middle region), each comprising a respective height and pitch, or in some embodiments, different flighting configurations.

In some cases, it may be preferred from a perspective of cost and/or ease of manufacture that flighting be installed on an inner surface of a sluicing barrel in many segments. For instance, and in accordance with embodiments, individual turns of fighting may comprise segmented flights. For example, a first turn (i.e. 360 degrees of barrel contour) of a flight may comprise 5 segments of a designated flight configuration (e.g. a sheet of metal bent into anchoring, baffling, and fighting portions), each segment constituting 72 degrees of a 360-degree turn. The next turn may in turn comprise another 5 segments. In accordance with different embodiments, such segments or turns may be installed to form a continuous flighting, or may be installed such that they overlap longitudinally by a designated amount to ensure upstream transport of dense particulates. It will further be understood that fighting may comprise any number of segments in various configurations, lengths (e.g. not limiting to integer numbers of segments per turn), and/or longitudinally overlapping regions, in accordance with various embodiments.

In alternative embodiments, such as those comprising multiple alternating flights (e.g. flights 312a and 312b of FIG. 3), different individual flights may comprise different configurations, heights, and/or an asymmetric spacing between adjacent flights (e.g. flights of varying pitch). It will further be appreciated that such variations, whether continuous or discreet, may be uniform, non-uniform, increasing/decreasing (e.g. tapered) in either an upstream or downstream direction, follow a pattern, or not follow a pattern, in accordance with different embodiments. In accordance with various embodiments, the variation described with respect to flighting configurations (e.g. height and separation) may similarly be descriptive of helical collection riffles. For instance, riffles may vary in configuration (e.g. square, round, triangular, etc.), depth, and/or separation between adjacent riffles in a cross-sectional of a sluicing barrel.

In accordance with some embodiments, outer separating cylinders, or sluicing barrels, may in turn comprise multiple components. For instance, while the outer cylinder 104 of FIGS. 1A and 1B may comprise a structure that is both directly rotatable via a drive means 120 and comprises a helical collection riffle and a spiral fighting, other embodiments may relate to an outer cylinder comprising a barrel insert or like structure on which a helical collection riffle and/or spiral flighting is disposed. In accordance with various embodiments, such a barrel may be provided within a conventional rotational to sluicing apparatus to, for instance, improve an efficiency of separation and concentration of dense particulates.

For example, the barrel structures schematically illustrated in FIGS. 2 to 10C may be a distinct component from other rotating sluice apparatus structures, such as the trommel 102, collection reservoir 124, drive means 120, input reservoir 108, and the like, of FIG. 1A. In accordance with some embodiments, a barrel comprising a helical collection riffle and spiral flighting may be inserted or otherwise introduced to an apparatus, such as the rotational sluicing system 100 of FIG. 1A, that is configured to rotate the barrel and perform any other necessary functions for sluicing. Accordingly, various embodiments herein disclosed may comprise a standalone sluicing barrel as enabled by the description herein provided related to any of the embodiments of a sluicing barrel or outer cylinder.

With reference now to FIGS. 11A and 11B, and in accordance with one exemplary embodiment, a continuous rotating sluice apparatus, generally referred to using the numeral 1100, will now be described. In this example, the apparatus 1100 in the left side view of FIG. 11A comprises a sluicing barrel 1102, in this case a hollow-bodied open-ended cylindrical barrel 1102, which in turn comprises a generalised spiral fighting portion 1104 and surrounds an inner trommel portion 1106. Similar to FIG. 1A, the trommel portion 1104 is configured to receive ore from an input reservoir 1108 at an upstream end thereof. In accordance with various embodiments, the sluicing barrel 1102 and trommel 1106 are mounted on a support frame 1112 configured to position the barrel 1102 and trommel 1104 at an angle 1114 relative to horizontal, such that a respective discharge end 1116 of each of the barrel 1102 and trommel 1106 is lower than the corresponding respective upstream end 1110. While, in this embodiment, the barrel 1102 and trommel 1106 are substantially concentric and forming the same angle 1114 with respect to horizontal (e.g. 0 degrees to 30 degrees), it will be understood that various embodiments relate to configurations in which the outer barrel 1102 and inner trommel 1106 are disposed at different respective angles from horizontal, and therefore do not necessarily share the same axis of rotation or lie completely concentrically. In accordance with such embodiments, the apparatus may further comprise a means (not shown) of adjusting an angular orientation of the barrel 1102 relative to the trommel 1106, or for adjusting the trommel 1106 relative to the barrel 1102.

In accordance with various embodiments, the frame 1112 may comprise one or more adjustable legs for, for instance, adjusting a height of either the discharge end 1116 or upstream end 1110 of the barrel 1102 and/or trommel 1106, or to stabilise the apparatus 1100. For instance, one or more of frame legs 1112a or 1112b may be adjustable, for instance via one or more screwing mechanisms, or other means known in the art to provide an adjustable length to a leg or support structure. Such embodiments may relate to, for instance, a sluicing apparatus 1100 for use on uneven terrain (e.g. a portable system for use in sluicing material from a stream bed, on a hillside, etc.).

In the exemplary embodiment of FIG. 11A, the apparatus 1100 further comprises a drive means 1118, such as a motor 1118, configured to provide a rotating force to the sluicing barrel 1102 and, in this embodiment, the trommel 1104 coupled thereto. In accordance with some embodiments, the drive means 1118 may be coupled to the barrel 1102 via a drive belt 1120 or other like means to rotate the outer cylinder 1102. Upon rotation of the barrel 1102 and trommel 1104, material introduced to the trommel 1104 from the input reservoir 1108 may be agitated by the rotation, encouraging transport from the upstream end 1110 to the discharge end 1116 of the apparatus, as well as facilitating breakup of the input material. While large particles will continue through the trommel 1106 for egress from the discharge end 1116 thereof, smaller particulates may then pass through a classifying mesh 1122 in the trommel 1104 onto the barrel 1102. In this embodiment, the particulates will then form a slurry with a carrier fluid introduced into the barrel 1102 from a fluid inlet at an upstream end 1110 thereof (not shown). As the slurry is transported towards the discharge end by gravity, it passes over fighting 1104 (and in accordance with some embodiments, helical collection riffles, not shown), creating flow patterns which allow low density particles to flow downstream and discharge from the discharge end 1116 of the barrel 1102. Simultaneously, the flow patterns allow dense particles to interact with the fighting 1104 and inner surface (and/or helical collection riffle) of the barrel 1102 such that, upon rotation of the barrel 1102, the dense particles are transported upstream for concentration in a collection reservoir (not shown).

In accordance with some embodiments, FIG. 11B is a front view of various components of the continuous rotational sluicing apparatus 1100 taken from the line 11B-11B of FIG. 11A. Shown in FIG. 11B is an additional adjustable leg 1112c for, for instance, adjusting a left-to-right tilt of the frame 1112, or to stabilise the apparatus 1100. Further, FIG. 11B shows an illustrative example of how the drive means 1118 from FIG. 11A may, in accordance with some embodiments, enable rotation 1124 of the sluicing barrel 1102 and trommel 1106 coupled therewith via a coupling means 1126 (e.g. bars 1126). In this example, the drive means 1118 is configured to rotate a disk 1128, which in turn rotates the sluicing barrel 1102 via the belt 1120. While in this embodiment, the disk 1128 and barrel 1102 have the same diameter, and will therefore rotate at the same angular speed, various other embodiments relate to the disk 1128 and barrel 1102 having different diameters, enabling different rotational speeds. For instance, and in accordance with one embodiment, the drive means 1128 may be configured so to couple with various exchangeable disks 1128, thereby enabling selectable speeds of rotation 1124 of the barrel 1102. In another embodiment, the barrel 1102 may be rotated by the drive means 1118 by a pulley system, which may, in some embodiments, comprise the disk 1128 and belt 1120, and/or additional components.

In the example of FIG. 11B, the barrel 1102 is disposed within a U-shaped structure 1130 of the frame 1112, and is in rotatable communication therewith via rotatable bearings 1132, shown in FIG. 11B as rotatable disks. In accordance with other embodiments, the barrel 1102 may be in rotatable communication with a U-shaped frame structure 1130 or a differently configured frame 1112 via other rotatable coupling means. For instance, the barrel 1102 may be disposed on cylindrical structures rotatably coupled to the frame 1112 and allowing the barrel 1102 to roll thereatop. In other embodiments, the frame 1112 may comprise a more robust frame for industrial use. For instance, the barrel 1102 may be in rotational communication with an industrial metal frame, or with the bed of a large truck, via a robust gear or cog coupled with an outer surface of the barrel 1102 to drive rotation.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A rotatable sluicing device for separating a heavy particulate material from lower density substrates and oversized particles in ore, the rotatable sluicing device comprising:
an inner trommel portion disposed substantially concentrically within an outer separating cylinder, said inner trommel portion comprising one or more porous regions to allow a material passage under a predetermined particle size therethrough to said outer separating cylinder, said outer separating cylinder comprising a rifled baffling portion disposed on an inner surface thereof and comprising:
a helical collection riffle; and
one or more spiral fighting portions disposed near and substantially parallel to an edge of said helical collection riffle;
a drive means for rotating said inner trommel portion and said outer separating cylinder; and
a fluid inlet for providing a liquid at a designated flow rate onto the inner surface of the outer separating cylinder for creating a slurry with said liquid and material received on said inner surface from said one or more porous regions;
wherein rotation of said inner trommel portion and said outer separating cylinder urges the lower density substrates to discharge from respective discharge ends thereof, and urges the heavy particulate material in said helical collection riffle to move upstream, opposite the respective discharge ends, for collection in a collection reservoir.

2. The rotatable sluicing device of claim 1, wherein said inner trommel portion is operably coupled to said outer separating cylinder so to synchronously rotate therewith.

3. The rotatable sluicing device of claim 1, wherein said one or more spiral fighting portions comprises a baffling portion extending inwardly at a designated angle from said inner surface of said outer separating cylinder, and a flight portion extending substantially in a direction towards said discharge end.

4. The rotatable sluicing device of claim 1, wherein said outer separating cylinder comprises a corrugated tube, and said helical collection riffle is a corrugation of said corrugated tube.

5. The rotatable sluicing device of claim 1, wherein said one or more spiral fighting portions is continuous along said inner surface of said outer separating cylinder.

6. The rotatable sluicing device of claim 1, wherein one or more of said spiral flighting or said helical collection riffle comprises a non-uniform radial profile along a longitudinal axis of said outer separating cylinder.

7. The rotatable sluicing device of claim 1, wherein said one or more spiral fighting portions and said helical collection riffle have a variable pitch relative to said inner surface of said outer separating cylinder.

8. The rotatable sluicing device of claim 1, wherein said one or more spiral fighting portions is reversibly coupled to said inner surface of said outer separating cylinder.

9. The rotatable sluicing device of claim 1, wherein said one or more spiral fighting portions is disposed near and substantially parallel to an upstream edge of said helical collection riffle.

10. A barrel for use in a rotating sluice, the barrel comprising:
a substantially rotationally symmetric open-ended elongated hollow body having respective upstream and downstream end regions and comprising, on an inner surface thereof:
a helical collection riffle; and
a spiral flighting disposed near and substantially parallel to an edge of said helical collection riffle;
wherein said helical collection riffle and said spiral fighting are configured to separate heavy particulates from a slurry flowing from said upstream end region to said downstream end region and, upon rotation of said substantially rotationally symmetric open-ended elongated hollow body, urge said separated heavy particulates towards said upstream end region.

11. The barrel of claim 10, wherein the barrel is configured to be inserted into a rotating sluicing apparatus.

12. The barrel of claim 10, wherein said spiral flighting comprises a baffling portion extending inwardly at a designated angle from said inner surface and a flight extending substantially in a direction towards said downstream end.

13. The barrel of claim 10, wherein said substantially rotationally symmetric open-ended hollow body comprises a corrugated tube, and said helical collection riffle is a corrugation of said corrugated tube.

14. The barrel of claim 10, wherein said spiral flighting is continuous along said inner surface.

15. The barrel of claim 10, wherein one or more of said spiral flighting or said helical collection riffle comprises a non-uniform radial profile along a longitudinal axis of said substantially rotationally symmetric open-ended elongated hollow body.

16. The barrel of claim 10, wherein said spiral flighting and said helical collection riffle have a variable pitch along a longitudinal axis of said substantially rotationally symmetric open-ended elongated hollow body.

17. The barrel of claim 10, wherein said spiral flighting is reversibly coupled to said inner surface.

18. The barrel of claim 10, wherein said spiral flighting is disposed near and substantially parallel to an upstream edge of said helical collection riffle.

19. The barrel of claim 10, wherein said helical collection riffle comprises a rounded profile.

20. A method of manufacturing a sluicing barrel for use in a rotating sluice, the method comprising:
providing a substantially rotationally symmetric open-ended elongated hollow body comprising a helical collection riffle on an inner surface thereof;
providing at least one rigid flighting material portion; and
coupling said at least one rigid fighting material portion to an inner surface of said substantially rotationally symmetric open-ended elongated hollow body such that said at least one rigid fighting material portion defines a spiral fighting near and substantially parallel to an edge of said helical collection riffle.
